(19) United States
(12) Patent Application Publication
(10) Pub. No.: US 2006/0196491 A1
(43) Pub. Date: Sep. 7, 2006

(54) Grill Having accessory attachment and grill accessories

(76) Inventors: Mark T. Proffitt, Greeneville, TN (US); G. L. Huff, Afton, TN (US); Douglas G. Wright, Morristown, TN (US)

Correspondence Address: MCGUIREWOODS, LLP, 1750 TYSONS BLVD, SUITE 1800, MCLEAN, VA, 22102, US

(21) Appl. No.: 11/353,200

(22) Filed: Feb. 14, 2006

Related U.S. Application Data
(60) Provisional application No. 60/652,896, filed on Feb. 15, 2005.

(51) Int. Cl. A47J 37/07; F24C 1/16

(52) U.S. Cl. 126/9 R

(57) ABSTRACT

Portable grill includes a grill accessory receiver portion arranged on the grill and configured to receive and hold at least one grill accessory, and a grill accessory attachment portion configured to be arranged on the at least one grill accessory. The grill accessory attachment portion engages with the grill accessory receiver portion to form a male-female coupling to provide a physical connection between the grill accessory and the grill.

### CROSS-REFERENCE TO RELATED APPLICATIONS

This application claims priority under 35 U.S.C. §119(e) to provisional U.S. Patent Application No. 60/652,896, filed on Feb. 15, 2005, the disclosure of which is expressly incorporated by reference herein in its entirety.

### BACKGROUND OF THE INVENTION

1. Field of the Invention

The invention is directed to a portable grill having an accessory attachment structure and a plurality of portable grill accessories for attachment thereto. More particularly, a portable grill having an accessory attachment and a plurality of portable grill accessories that may be quickly and easily attached to and removed from the accessory attachment of the portable grill.

2. Related Art

Many devices, such as barbecue grills and the like may utilize various accessories to increase the functionality and versatility thereof. However, typically, these accessories require complex connections, such as mechanical fasteners and the like, that need to be manipulated for the attachment and removal of the accessories to and from the grill. This makes the accessory less useful in operation and less pleasing to the user.

Accordingly, there is a need for a device, such as a grill that includes an accessory attachment configuration that allows accessories to be attached to and removed from the grill quickly and easily.

### SUMMARY OF THE INVENTION

The invention meets the foregoing needs with an accessory attachment configuration, which results in a significantly easier accessory attachment and removal, and includes other advantages apparent from the discussion herein.

Accordingly, in one aspect of the invention a portable grill includes a grill accessory receiver portion arranged on the grill and configured to receive and hold at least one grill accessory, a grill accessory attachment portion configured to be arranged on the at least one grill accessory, wherein the grill accessory attachment portion engages with the grill accessory receiver portion to form a male-female coupling to provide a physical connection between the grill accessory and the grill.

The portable grill further may include a plurality of the grill accessory receiver portions for attaching a plurality of grill accessories. The accessory receiver portion and the accessory attachment portion may have complimentary shapes that include one of a cylinder, a substantially cylindrically shaped surface, a cube, a rectangular prism, a pyramid, a cone, a polygon or combinations thereof. The portable grill may include at least one fuel tank arranged on the grill to provide fuel to at least one of the grill and the grill accessory, and a plurality legs arranged to support the portable grill. The grill accessory may include one of a side burner, a lantern, a smoker, a hot water dispenser, a coffee maker, a heater, a steamer, or a battery powered lamp. The grill accessory further may include a fuel line connection that connects through the grill accessory receiver portion to provide fuel to the at least one grill accessory. The accessory may include a lantern and the lantern may include an extension pole, a valve with a regulator, a housing, a burner, a burner housing, a globe, a globe clip, and a top shield. The accessory may include a side burner and the side burner may include a gas train, a side burner, a side burner table, a side burner shroud, a grid, and a side burner cover.

According to another aspect of the invention a method of attaching an accessory to a grill includes the steps of arranging a grill accessory receiver portion on the grill to receive and hold at least one grill accessory, arranging a grill accessory attachment portion on a grill accessory, and the grill accessory attachment portion engages with the grill accessory receiver portion to form a male-female coupling to provide a physical connection between the grill accessory and the grill.

The method may include the step of inserting the accessory attachment portion into the grill attachment receiver portion to attach the accessory to the grill without tools. The method further may include the step of attaching a fuel line of the accessory to a fuel tank of the grill. The accessory receiver portion and the accessory attachment portion may have complimentary shapes that include one of a cylinder, a substantially cylindrically shaped surface, a cube, a rectangular prism, a pyramid, a cone, a polygon or combinations thereof. The grill accessory may include one of a side burner, a lantern, a smoker, a hot water dispenser, a coffee maker, a heater, a steamer, or a battery powered lamp.

In yet another aspect of the invention a portable grill includes a grill accessory receiver portion arranged on the grill and configured to receive and hold at least one grill accessory, a grill accessory attachment portion arranged on the at least one grill accessory, wherein the grill accessory attachment portion is configured to be vertically inserted into the grill accessory receiver portion to form a coupling to provide a physical connection between the grill accessory and the grill.

The portable grill further may include a plurality of the grill accessory receiver portions for attaching a plurality of grill accessories. The accessory receiver portion and the accessory attachment portion may have complimentary shapes that include one of a cylinder, a substantially cylindrically shaped surface, a cube, a rectangular prism, a pyramid, a cone, a polygon or combinations thereof. The portable grill further may include at least one fuel tank arranged on the grill to provide fuel to at least one of the grill and the grill accessory, and a plurality legs arranged to support the portable grill. The grill accessory may include one of a side burner, a lantern, a smoker, a hot water dispenser, a coffee maker, a heater, a steamer, or a battery powered lamp. The portable grill further may include a fuel line connection that connect through the grill accessory receiver portion to provide fuel to the at least one grill accessory. The accessory may include a lantern and the lantern may include an extension pole, a valve with regulator, a housing, a burner, a burner housing, a globe, a globe clip, and a top shield. The accessory may include a side burner and the side burner may include a gas train, a side burner, a side burner table, a side burner shroud, a grid, and a side burner cover.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a side burner accessory positioned separate from a portable grill prior to connecting the accessory to the grill constructed according to the principles of the invention;

FIG. 2 shows the side burner and the portable grill of FIG. 1 with the side burner attached to the portable grill;

FIG. 3 shows the side burner and a partial detailed view of the portable grill of FIG. 2;

FIG. 4 shows a lantern accessory positioned separate from a portable grill and pole prior to connecting the accessory to the grill and pole constructed according to the principles of the invention;

FIG. 5 shows the lantern and the portable grill of FIG. 1 with the lantern attached;

FIG. 6 shows a partial detailed view of the lantern accessory connected to a portable grill of FIG. 5;

FIG. 7 shows another embodiment the portable grill having two accessories attached to two attachments constructed according the principles of the invention;

FIG. 8 shows an exploded view of an exemplary side burner constructed according to the principles of the invention;

FIG. 9 is an exploded side view of the FIG. 8 side burner;

FIG. 10 is a side view of the assembled side burner of FIG. 8;

FIG. 11 is a perspective view of the assembled side burner according to FIG. 8;

FIG. 12 is an exploded view of an exemplary lantern constructed according to the principle of the invention;

FIG. 13 is a side view of a lantern of FIG. 12;

FIG. 14 is a perspective view of the lantern of FIG. 12;

FIG. 15 shows an exploded view of only the lantern assembly constructed according to the principles of the invention; and

FIG. 16 shows a perspective view of the assembled lantern of FIG. 12.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

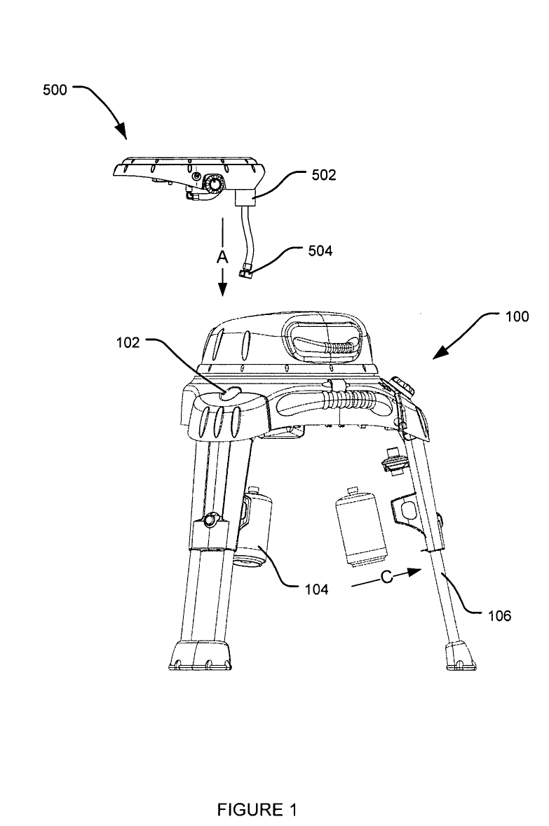

In particular, FIGS. 1, 2, and 3 show a portable grill 100 that includes a grill accessory attachment receiver 102 and a fuel tank 104 that may connect to the accessory. In particular, the grill accessory attachment receiver 102 is structured and arranged such that it can receive any one of a plurality of different accessories. Particularly, the grill accessory attachment receiver 102 provides a physical connection to the accessory through a female-male coupling to hold the accessory in position in a stable manner such that the accessory provides its function and will not collapse or fall. The fuel tank 104 of the grill 100 may be arranged below the grill accessory attachment receiver 102 and may be attached to a leg 106 by inserting in the C direction towards the leg. Corresponding arms may be arranged on the leg 106 that may configured to flex and engage the fuel tank 104. The fuel tank 104 may provide fuel to any one of the plurality of accessories that may be attached at the grill accessory attachment 102 that requires fuel.

The grill 100 may employ the portable grill described in U.S. patent application Ser. No.: 11/260,692, filed; Oct. 28, 2005, Titled: PORTABLE GAS GRILL, by Inventors: Mark T. PROFFITT, et al., the disclosure of which is hereby incorporated by reference herein in its entirety.

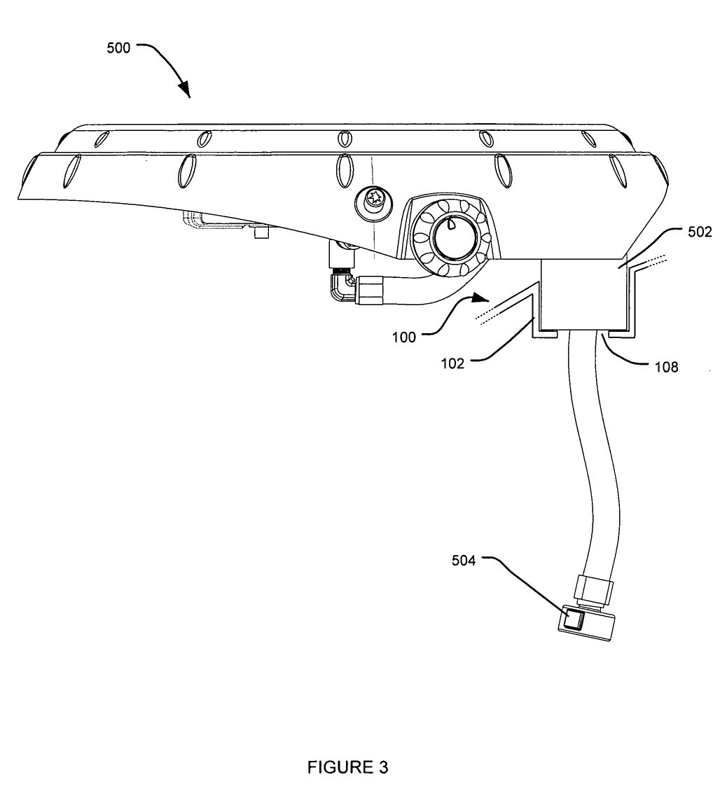

As further shown in FIGS. 1, 2, and 3, the accessory, such as side burner 500 includes an attachment 502 that may have a partially cylindrical shape. This partially cylindrical shape attachment 502 engages with a corresponding partially cylindrical shaped grill attachment receiver 102 as shown in detail in FIG. 3. In particular, the partially cylindrical shape may be cylindrical except for a scalloped portion arranged along one side to accommodate additional structure. The partially cylindrical shape provides an engaging surface that will hold the accessory, such as the side burner 500, in an upright position but keeps the accessory from rotating. The attachment 502 may also employ a cylindrical shape such that it allows the side burner 500 to rotate with a limited degree of freedom left and right. The particular cross-sectioned shape of the accessory attachment 502, such as the side burner attachment 502, is merely exemplary. Any particular cross-section shape may be used with the accessory attachment including a D-shaped, star-shaped, square-shaped, rectangular-shaped, conical-shaped, pyramid-shaped, polygon-shaped, combinations thereof or the like. Moreover, the female and male arrangement of the attachment shown in the Figures may be reversed. It should be noted that, however, that any particular accessory attachment 502 and grill attachment receiver 102 configuration is contemplated by the invention that provides any easy substantially vertically interacting male-female coupling.

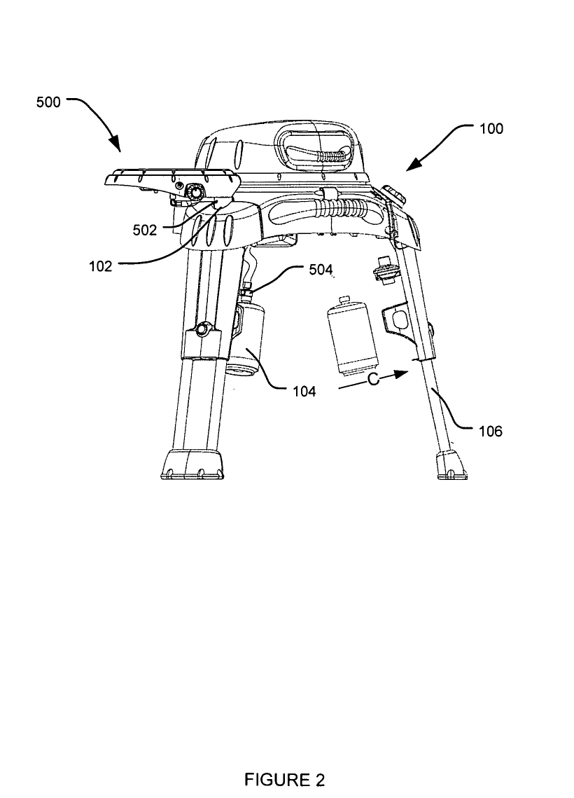

FIGS. 1, 2, and 3 further show an exemplary accessory of a side burner 500. The side burner 500 may include a side burner attachment 502 and a side burner fuel line connection 504. In particular, the side burner attachment 502 may be structured and arranged on the side burner accessory 500 such that it may engage the grill accessory attachment receiver 102. Accordingly, when the side burner 500 is inserted with the side burner attachment 502 into the grill accessory attachment receiver 102 in the direction A shown in FIG. 1, the accessory will be tightly held. The completed attachment is shown in FIG. 2 and 3.

With the side burner 500 having a side burner attachment 502 engaged with the grill accessory attachment receiver 102, the side burner 500 will have a solid connection to the grill 100 and remain stable therewith. This is created by a tight slip-fit or press-fit connection between the grill accessory attachment receiver 102 and the side burner attachment 502. Additionally, the side burner 500 may connect to the fuel tank 104 to obtain fuel. In particular, the side burner fuel line may extend through the grill accessory attachment receiver 102 through a hole 108 down below the grill 100 and attach to the fuel tank 104.

Accordingly, as shown in the FIG. 1 and 2 exemplary embodiment, the accessory, in this case, the side burner 500, has been attached to the grill 100 easily and quickly by inserting the side burner attachment 502 into the partially cylindrical grill accessory attachment receiver 102 and subsequently attaching the side burner fuel line connection 504 to the fuel tank 104.

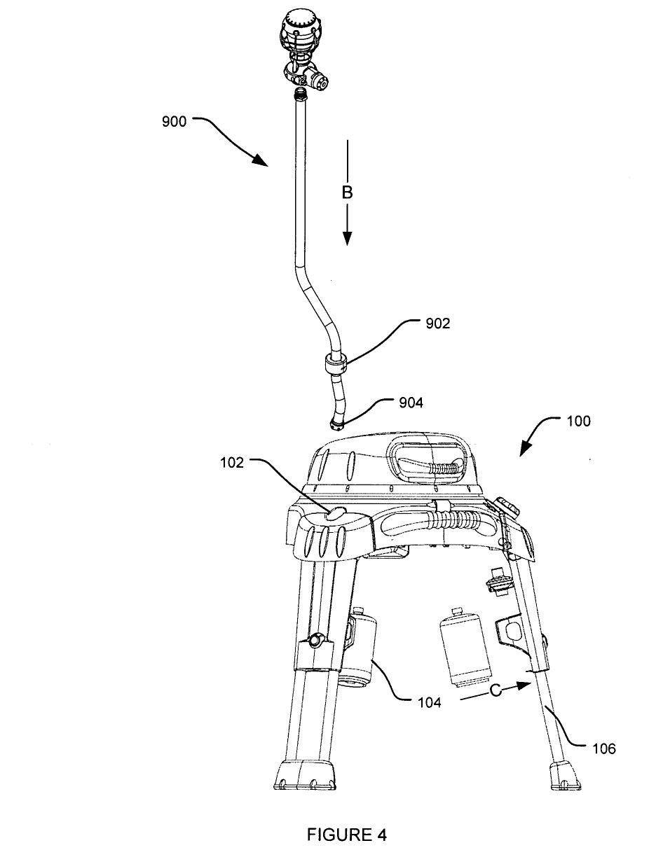

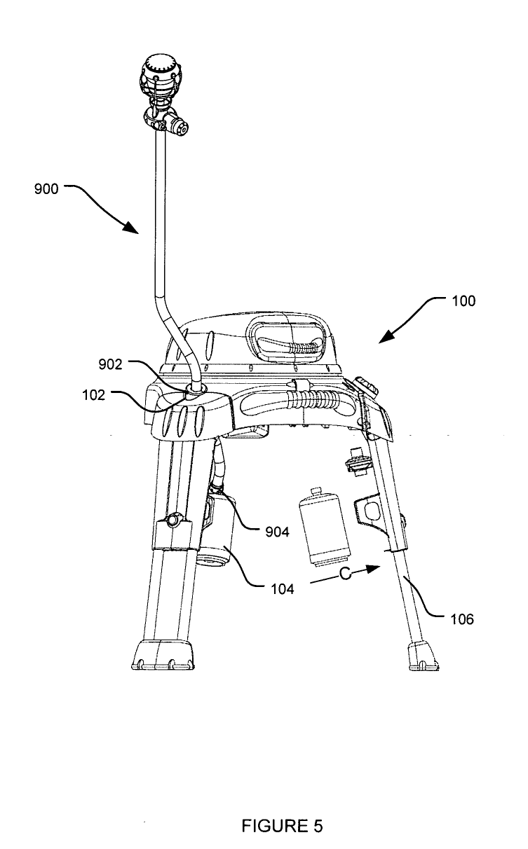

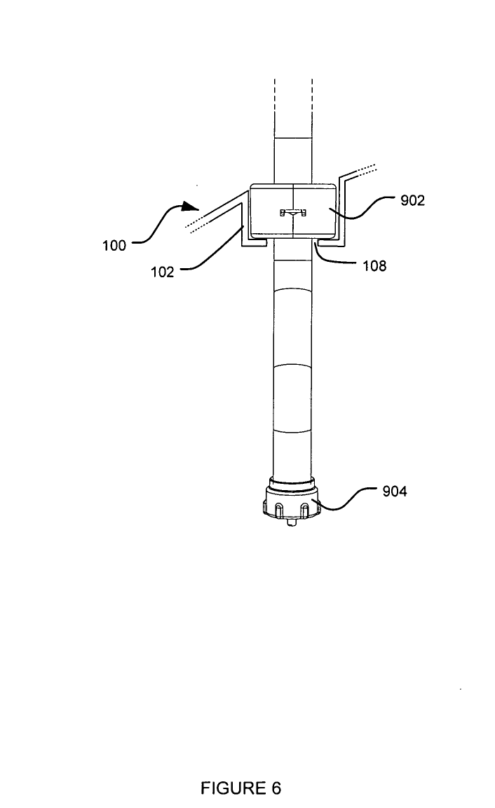

FIGS. 4, 5, and 6 show a lantern 900 that may be inserted and attached to the grill 100. In particular, the grill 100 again has a partially cylindrical accessory attachment receiver 102 as described above. In this regard, the lantern 900 includes a lantern attachment 902. The lantern attachment 902 may insert into the grill accessory attachment receiver 102 to again provide a stable physical connection between the lantern 900 and the grill 100. Additionally, a lantern fuel line connection 904 may extend through grill accessory attachment receiver 102, hole 108, and attach to fuel tank 104 in a manner similar to that of the FIGS. 1, 2, and 3 embodiment as shown in FIG. 6. Accordingly, by inserting the lantern 900 as shown in FIG. 3 in the direction B, and attaching the lantern portion as described below the lantern is attached is shown in FIG. 5.

The accessory attachments allow a user of the grill 100 to attach the accessory such as the side burner 500 or the lantern 900 to the grill 100 without tools. In this regard, the side burner attachments 502 or the lantern attachment 902 provide a slip fit or press-fit connection into the grill attachment receiver 102 to provide a strong physical connection without any tools. However, if desired, mechanical fasteners may be used to further secure the accessory, such as the side burner 500 or the lantern 900 through the side burner attachment 500 or the lantern 900 to the grill 100, to provide a stronger attachment thereto.

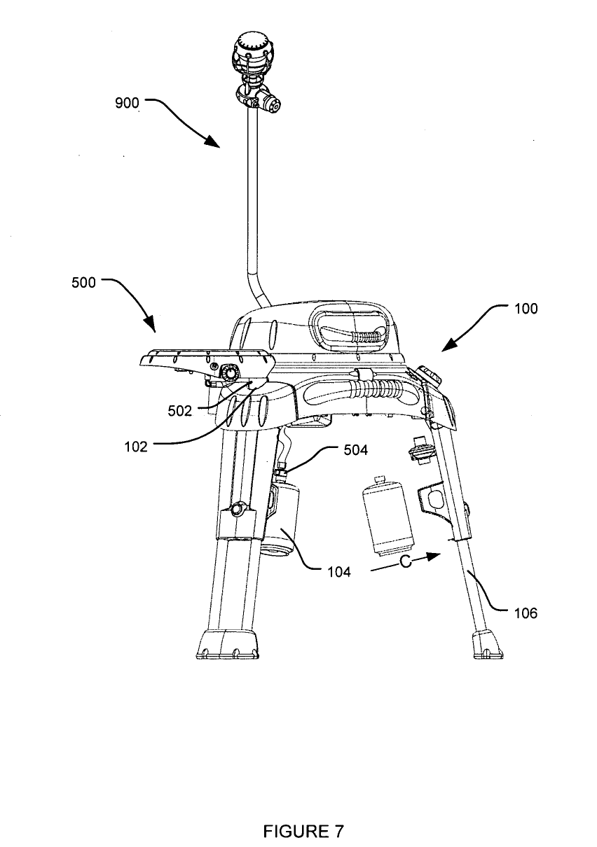

FIG. 7 shows an embodiment with another accessory attachment 102 arranged on a back leg of grill 100 to allow a second accessory to be attached. In this regard any number of accessory attachments are contemplated by the invention.

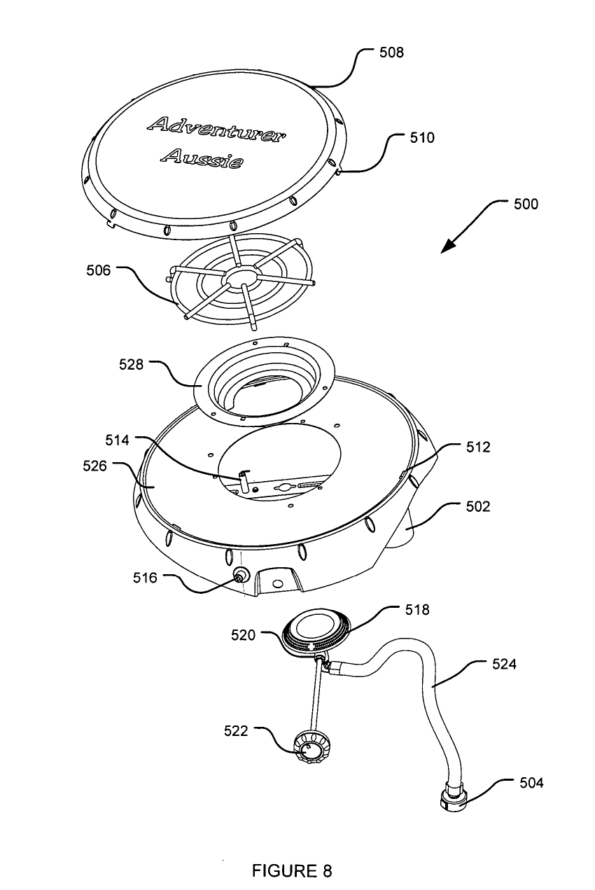

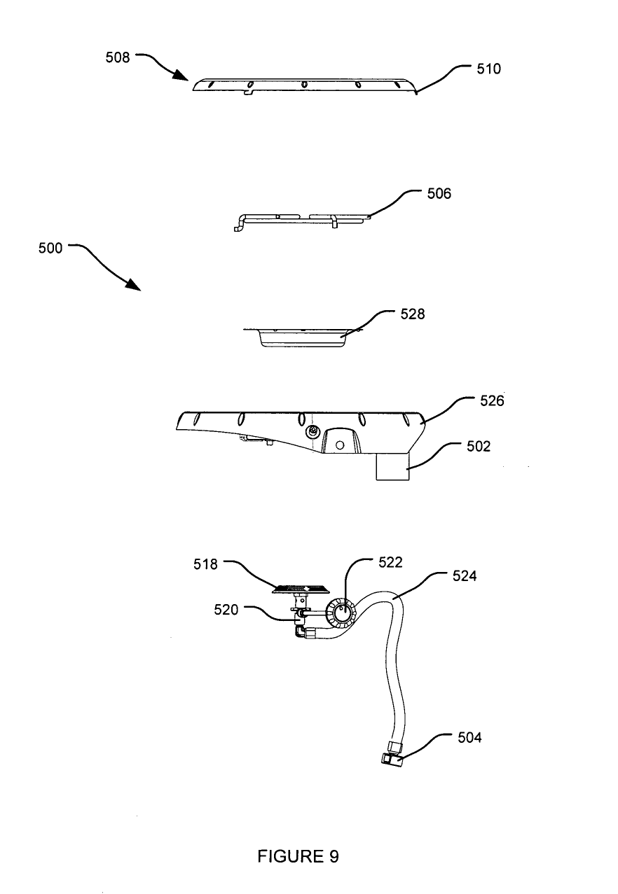

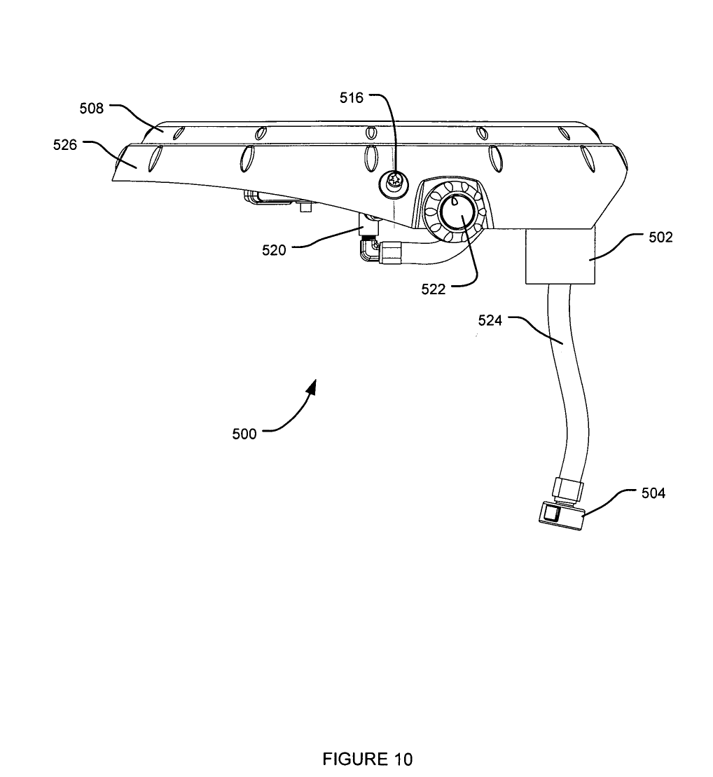

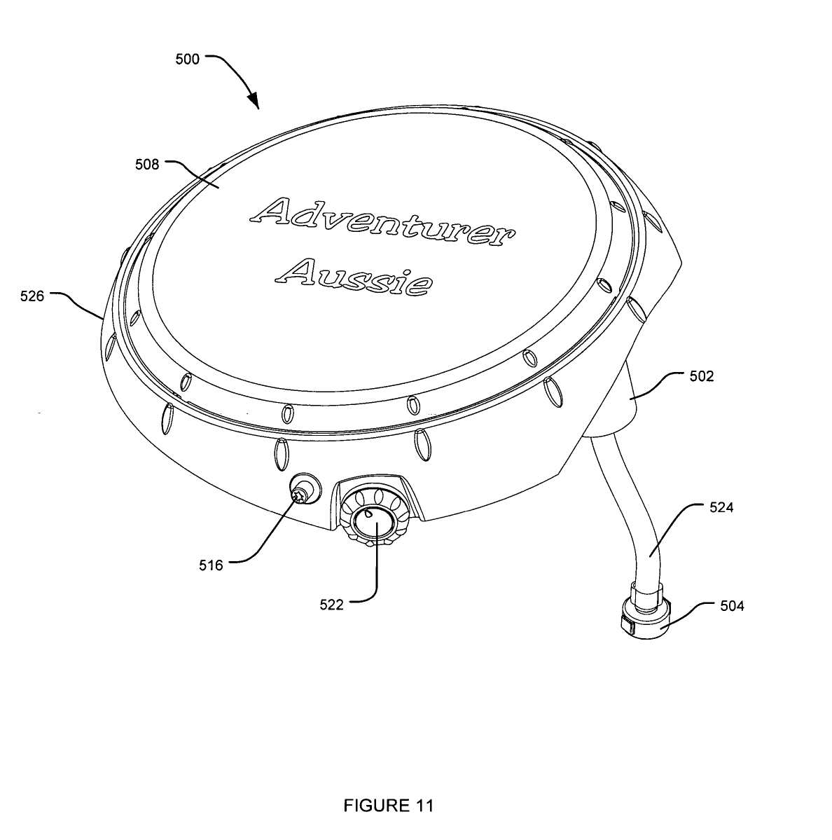

In particular, FIGS. 8, 9, 10, and 11 show the side burner 500 that includes a fuel line connection 504 that may connect to the fuel tank 104 (not shown) with a hose connection which may be any known type of hose connection such as a threaded brass fitting. Fuel from the fuel tank 104 may then travel through a side burner hose 524. The side burner hose 524 may provide fuel to a burner control valve 520. The burner control valve 520 may be actuated by a burner control knob 522 which may open or close a valve to provide fuel to a burner 518. The burner 518 includes a plurality of holes that may allow the mixing of air with the fuel and provide a surface for which the two may burn. The burner 518, burner control valve 520, and burner control knob 522 may all be arranged within a side burner table 526 that may include the side burner attachment 502 discussed previously.

The side burner table 526 may also include an ignitor 514 such as a piezoelectric ignitor. The igniter 514 may be actuated by an ignitor button 516. Pressing the ignitor button 516 may cause the ignitor 514 to discharge a spark adjacent to the burner 518 to ignite a flame from the fuel being output therefrom. In addition, the side burner table 526 may include locking slots 512. The locking slots 512 may engage corresponding locking tabs 510 arranged on a side burner cover 508. Accordingly, when the side burner cover 508 is placed on top of the side burner table 526 and slightly rotated a few degrees, the locking tab 510 will engage with the locking slot 512 to lock the side burner cover 508 onto the side burner table 526.

Additionally, the side burner 500 may include a side burner grid 506 constructed of metallic materials, for example only. The side burner grid 506 may be positioned above a side burner shroud 528 to support a pot or pan thereabove. Accordingly, the burner 518 may be positioned within the side burner shroud 528 and below the side burner grid 506. Accordingly, this exemplary construction provides a convenient side burner functioning as is well know in the art. Moreover, the side burner cover 508 may be a multi-function component. For example, it may be used as a table top when side burner 500 is not used to support various items. Additionally, it may function as a tray to hold drinks, food, or the like when disconnected from the side burner table 526 and inverted.

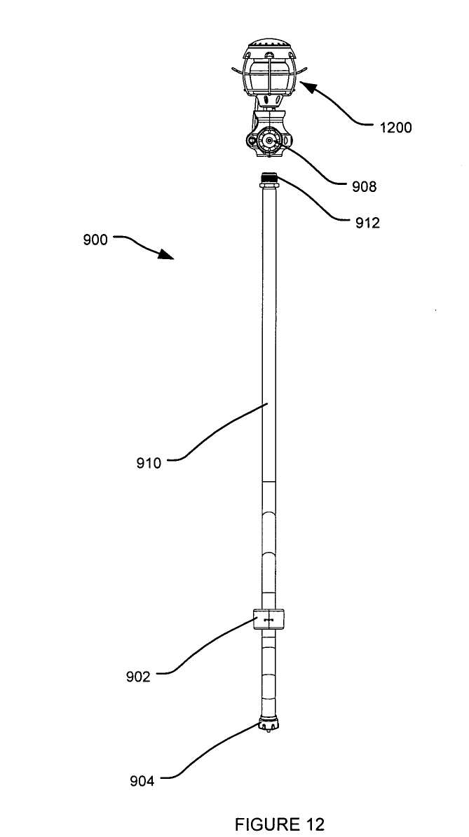

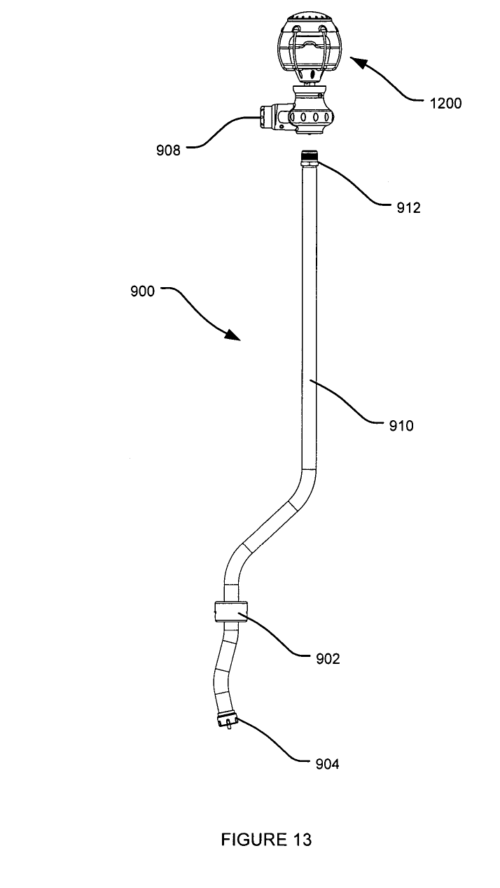

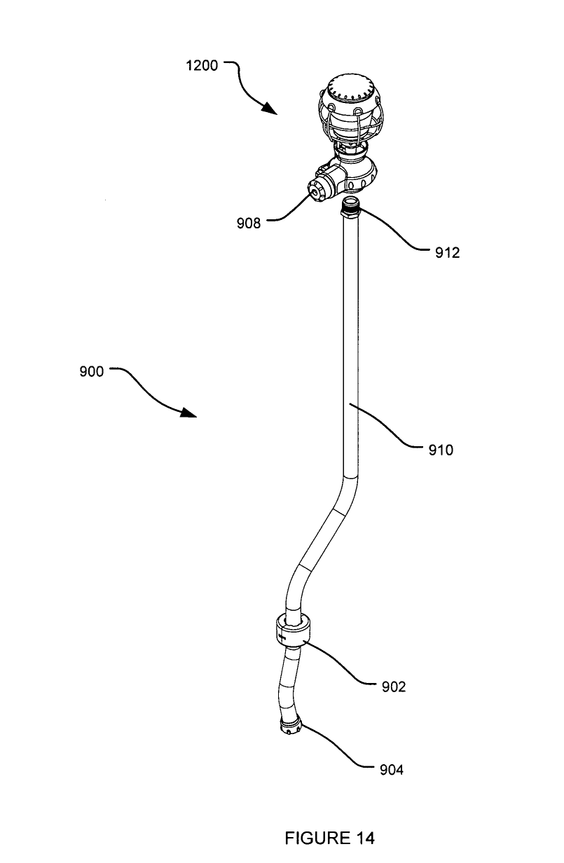

FIGS. 12, 13, and 14 show an exemplary construction of the lantern accessory 900 for use with the grill 100. In particular, the lantern 900 may include the previously described lantern attachment 902 and the lantern fuel line connection 904. Again, the lantern attachment 902 provides a physical attachment of the lantern 902 to the grill 100 and the lantern fuel line connection 904 provides a fuel connection from the grill 100 and more specifically, to the fuel tank 104 to the lantern 900. Additionally, the lantern 900 includes an extension pole 910. The extension pole 910 extending the vertical position of a lantern portion 1200 above the grill. The extension pole 910 may be formed of steel tubing and include brass connections at each end. Additionally, the lantern portion 1200 may include a lantern control knob 908 described in greater detail below. The lantern portion 1200 is attached to the extension pole 910 with a male connector 912 arranged on an upper end of the extension pole 910. This connection may be formed of a brass material. Additionally, the lantern portion 1200 may include a corresponding female connector (not shown) to connect with the connector 912.

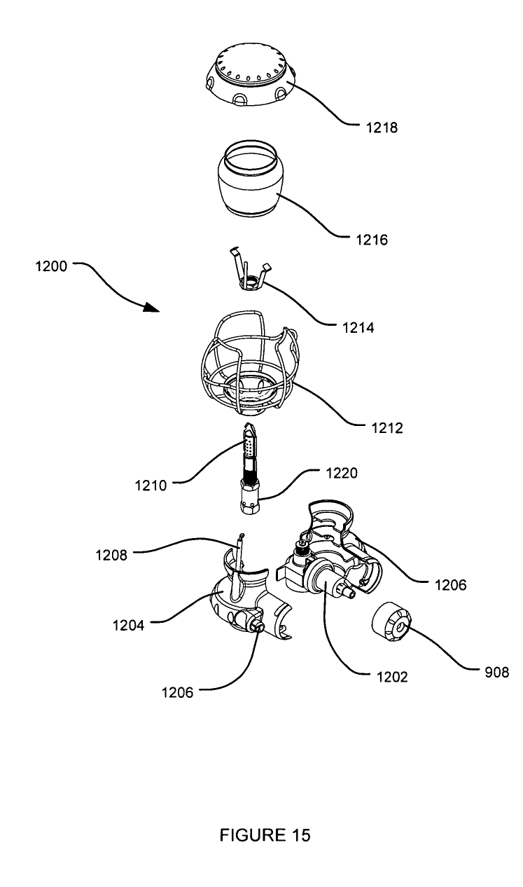

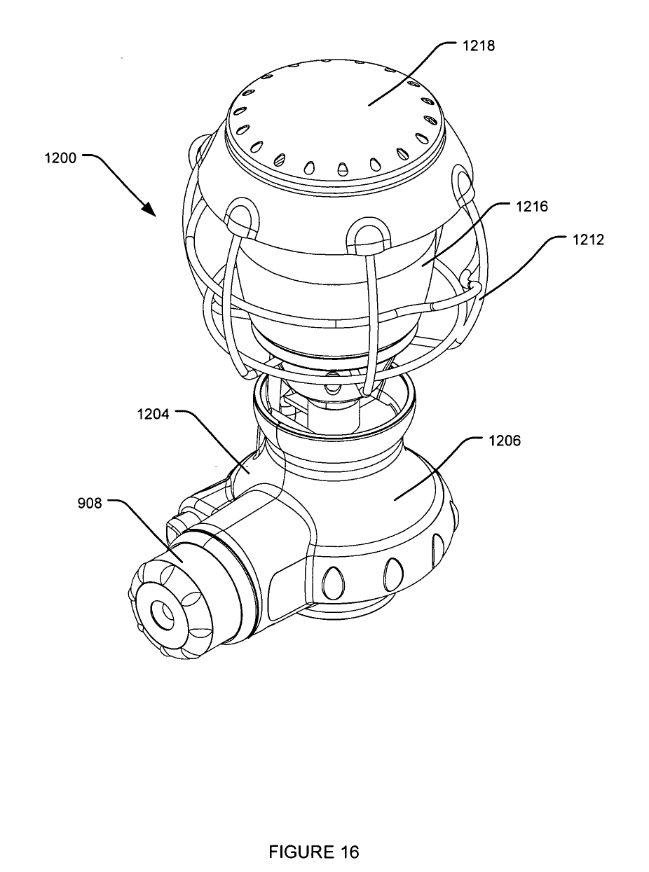

FIGS. 15 and 16 show an exemplary construction of the lantern portion 1200. In particular, the lantern portion 1200 includes a valve-regulator 1202. The valve-regulator 1202 is arranged within a housing. The housing includes a left-side housing 1204 and a right-side housing 1206. The left-side housing 1204 may include an ignitor 1208 that is operated by an ignitor button 1206. In particular, when fuel is supplied to the lantern 1200, pressing the ignitor button 1206, may provide a spark at the ignitor 1208 to cause the fuel to burn. Additionally, the lantern portion 1200 includes a lantern control knob 908. Lantern control knob 908 provides a connection to the valve-regulator 1202 to control the amount of fuel provided to a burner 1210. The burner 1210 may include an extension 1220. The burner 1210 and extension 1220 are arranged inside of a burner housing and a shield 1212 and furthermore, inside of a globe clip 1214. A globe 1216 having, for example, a glass construction, is arranged inside the burner housing and shield 1212 and over the clip 1214. The clip 1214 may engage the globe 1216 to provide a firm connection thereto. Additionally, on a top of the globe 1216 is a top shield 1218 that may also engage the burner housing and shield 1212.

Although a specific grill 100 construction is shown in FIGS. 1 to 16, any type of grill construction may be used with the invention as long as it has an accessory attachment that easily engages with an accessory such as shown in the FIGS. 1 through 16. Additionally, any construction of the side burner 500 or lantern 900 may also be used with the invention. The construction shown in FIGS. 1 through 16 is merely exemplary and the invention is not limited to those particular embodiments. Additionally, even though only a lantern and a side burner accessory are shown and described with the invention, any number of accessories may be used with the grill 100. For example only, a smoker, such as a rib smoker, steaming device, side table (with no burner capability), electric lantern (with no fuel connection), coffee maker, water heater, heater or the like may be used an accessory with the grill 100 according to the principles of the invention. Additionally, the accessories, such as the side burner 500 and the lantern 900, together with the grill 100 may be carried with or in a holder that is structured to hold the same. Such a holder may have a rigid construction or have a more flexible construction. The holder may furthermore include any one or more of shoulder straps, back pack straps, handles, wheels, or the like to make carrying easier.

Additionally, the invention may employ a safety valve for any one of the above-described accessories such as the one shown in U.S. patent application Ser. No. 11/331,119 filed Jan. 13, 2006, to G. L. Huff, et al. for a SAFETY VALVE HAVING SWIVEL CONNECTOR, the disclosure of which is incorporated by reference herein in its entirety.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

1. A grill comprising:
a grill accessory receiver portion arranged on the grill and configured to receive and hold at least one grill accessory;
a grill accessory attachment portion configured to be arranged on the at least one grill accessory;
wherein said grill accessory attachment portion engages with said grill accessory receiver portion to form a male-female coupling to provide a physical connection between the grill accessory and the grill.

2. The grill according to claim 1 further comprising a plurality of said grill accessory receiver portions for attaching a plurality of grill accessories.

3. The grill according to claim 1 wherein said accessory receiver portion and said accessory attachment portion have complimentary shapes that comprise one of a cylinder, a substantially cylindrically shaped surface, a cube, a rectangular prism, a pyramid, a cone, a polygon or combinations thereof.

4. The grill according to claim 1 further comprising:
at least one fuel tank arranged on the grill to provide fuel to at least one of the grill and the grill accessory; and
a plurality legs arranged to support the portable grill.

5. The grill according to claim 1 wherein the grill accessory comprises one of a side burner, a lantern, a smoker, a hot water dispenser, a coffee maker, a heater, a steamer, or a battery powered lamp.

6. The grill according to claim 1 wherein the grill accessory further comprises a fuel line connection that connects through said grill accessory receiver portion to provide fuel to the at least one grill accessory.

7. The grill according to claim 1 wherein said accessory comprises a lantern and said lantern comprises an extension pole, a valve with a regulator, a housing, a burner, a burner housing, a globe, a globe clip, and a top shield.

8. The grill according to claim 1 wherein said accessory comprises a side burner and said side burner comprises a gas train, a side burner, a side burner table, a side burner shroud, a grid, and a side burner cover.

9. A method of attaching an accessory to a grill comprising the steps of:
arranging a grill accessory receiver portion on the grill to receive and hold at least one grill accessory;
arranging a grill accessory attachment portion on a grill accessory;
wherein the grill accessory attachment portion engages with the grill accessory receiver portion to form a male-female coupling to provide a physical connection between the grill accessory and the grill.

10. The method according to claim 9 further comprising the step of:
inserting the accessory attachment portion into the grill attachment receiver portion to attach the accessory to the grill without tools.

11. The method according to claim 10 further comprising the step of:
attaching a fuel line of the accessory to a fuel tank of the grill.

12. The method according to claim 9 wherein said accessory receiver portion and said accessory attachment portion have complimentary shapes that comprise one of a cylinder, a substantially cylindrically shaped surface, a cube, a rectangular prism, a pyramid, a cone, a polygon or combinations thereof.

13. The method according to claim 9 wherein the grill accessory comprises one of a side burner, a lantern, a smoker, a hot water dispenser, a coffee maker, a heater, a steamer, or a battery powered lamp.

14. A grill comprising:
a grill accessory receiver portion arranged on the grill and configured to receive and hold at least one grill accessory;
a grill accessory attachment portion arranged on the at least one grill accessory;
wherein said grill accessory attachment portion is configured to be vertically inserted into said grill accessory receiver portion to form a coupling to provide a physical connection between the grill accessory and the grill.

15. The grill according to claim 14 further comprising a plurality of said grill accessory receiver portions for attaching a plurality of grill accessories.

16. The grill according to claim 14 wherein said accessory receiver portion and said accessory attachment portion have complimentary shapes that comprise one of a cylinder, a substantially cylindrically shaped surface, a cube, a rectangular prism, a pyramid, a cone, a polygon or combinations thereof.

17. The grill according to claim 14 further comprising:
at least one fuel tank arranged on the grill to provide fuel to at least one of the grill and the grill accessory; and
a plurality legs arranged to support the grill.

18. The grill according to claim 14 wherein the grill accessory comprises one of a side burner, a lantern, a smoker, a hot water dispenser, a coffee maker, a heater, a steamer, or a battery powered lamp.

19. The grill according to claim 14 wherein the grill accessory further comprises a fuel line connection that connect through said grill accessory receiver portion to provide fuel to the at least one grill accessory.

20. The grill according to claim 14 wherein said accessory comprises a lantern and said lantern comprises an extension pole, a valve with regulator, a housing, a burner, a burner housing, a globe, a globe clip, and a top shield.

21. The grill according to claim 14 wherein said accessory comprises a side burner and said side burner comprises a gas train, a side burner, a side burner table, a side burner shroud, a grid, and a side burner cover.
